(19) United States
(12) Patent Application Publication
(10) Pub. No.: US 2025/0043433 A1
(43) Pub. Date: Feb. 6, 2025

(54) ELECTROCHEMICAL CELL WITH REDUCED OVERPOTENTIAL

(71) Applicant: Brunel University London, Uxbridge (GB)

(72) Inventor: Abhishek Lahiri, Uxbridge (GB)

(73) Assignee: Brunel University London, Uxbridge (GB)

(21) Appl. No.: 18/718,712

(22) PCT Filed: Dec. 15, 2022
(86) PCT No.: PCT/GB2022/053254

§ 371 Date: Jun. 11, 2024

(30) Foreign Application Priority Data
Dec. 17, 2021 (GB) 2118429.6

(51) Int. Cl. C25B 1/04; C25B 11/043; C25B 15/021

(52) U.S. Cl. CPC C25B 1/04; C25B 11/043; C25B 15/021

(57) ABSTRACT

An electrochemical cell includes an anode, a cathode and an electrolyte in contact with the anode and the cathode, wherein the electrolyte and at least one of the anode or the cathode includes a compound which compound includes either an amino group or a carboxyl group or both (preferably an amino acid, a peptide, or a combination thereof). Alternatively, if the anode is formed from a combination of a metal and a metal oxide, then the electrolyte and/or at least one of the anode or the cathode can include said compound (i.e. it does not have to be present on both). Use of these cells significantly reduces the overpotential of the electrochemical splitting of water, thereby enabling the production of hydrogen in a much more energy efficient manner.

The present application relates to a method of electrolysis, and in particular to a method for producing hydrogen from an aqueous solution in which the electrochemical overpotential is reduced.

Electrolysis is a well-known technique in which a chemical reaction is driven by applying an electric current across a liquid (known as an electrolyte) in order to drive a chemical reaction. Electrolysis can be used to decompose an electrolyte, for example in the electrolytic decomposition of water to produce oxygen and hydrogen gas. The production of hydrogen gas by this method is relatively environmentally friendly (compared to the thermochemical production of hydrogen by burning fossil fuels or biomass) because no carbon emissions are produced.

The minimum potential difference that is required to drive an electrochemical reaction is known as the “decomposition potential”. In the case of the electrolysis of water, it is about 1.23V. However, in practice the potential difference is higher than this due to inefficiencies in the electrochemical cell or process. The additional voltage compared to the decomposition potential that is required in practice to drive the reaction is known as the “overpotential”. Clearly, high overpotentials require greater electrical energy to drive the reaction and there is a need to reduce overpotentials for reasons of energy efficiency and to make the process more environmentally friendly.

It is well-known to reduce the decomposition potential of pure water by adding an acid, a base or a salt to the water to create an aqueous solution which is easier to decompose by electrolysis. However, there will still be an overpotential caused by electrochemical inefficiencies and there is a need to reduce this if at all possible.

### BACKGROUND ART

US 2009/294282 A1 (Commissariat Energie Atomique et al.) discloses an electrolysis device intended to produce hydrogen by the reduction of water, comprising a cathode compartment, an anode compartment, and an element connecting said compartments and allowing ions to migrate between them, the device being characterized in that the cathode compartment contains at least one weak acid capable of catalyzing the reduction and an electrolytic solution, the pH of which is in the range between 3 and 9.

EP 0849378 A1 (Tosoh Corp.) discloses a cathode with a low hydrogen overvoltage which is useful for electrolysis of water and electrolysis of an aqueous alkali metal chloride such as sodium chloride. A process for producing the cathode is also provided. Another solution is disclosed in JP H11172483A in the name of the same applicant.

RU 2499601C1 (OOO Etk Farmatsevtika) discloses a method for preparing an antiviral composition solution which contains complex silver, glycine complex bound to silver, sodium glycinate and water in certain proportions. The method for preparing the above antiviral composition solution consists in electrolysis of the solution containing the glycine compounds and sodium glycinate to provides the electric conductivity of the solution.

CN 114261956A (Univ Shaanxi Normal) discloses a photo-anode water decomposition electrolyte solution based on amino acid carbon dots, which is characterized in that amino acid is used as a precursor.

Other background art includes US2020040467A1; US2012305407A1; US2012097551A1; CN110890557A; and “Reduced overpotentials in microbial electrolysis cells through improved design, operation, and electrochemical characterization”, Dongwon et al., Chemical Engineering Journal, March 2016, DOI: 10.1016/j.cej.2015.11.022.

### SUMMARY OF THE INVENTION

In accordance with a first aspect of the invention, there is provided an electrochemical cell including an anode, a cathode and an electrolyte in contact with the anode and the cathode, wherein the electrolyte and at least one of the anode or the cathode includes a compound which compound includes either an amino group or a carboxyl group or both.

It has been discovered that surprisingly the inclusion of at least one compound having an amino group and/or a carboxyl group (preferably an amino acid, a peptide, or a combination thereof) in the electrolyte and on the cathode or (preferably) anode significantly reduces the overpotential of the electrochemical splitting of water, thereby enabling the production of hydrogen in a much more energy efficient manner.

Alternatively, if the anode is formed from a combination of a metal and a metal oxide, then the electrolyte and/or at least one of the anode or the cathode can include said compound (i.e. it does not have to be present on both).

The anode may be formed from carbon, a metal, or a combination of a metal and a metal oxide (in the case of the second embodiment for example). Preferably the anode is formed from a metal with a surface layer which includes a metal oxide. Any suitable metal oxide may be used, for example manganese oxide, cobalt-doped manganese oxide, nickel oxide or iron oxide. A combination may be used.

The cathode may be formed of nickel plate, nickel foam, copper plate or stainless-steel plate.

Preferably said compound includes an amino group and a carboxyl group. Most preferably said compound is an amino acid (such as glycine, glycylglycine, alanine, serine), a peptide, or any combination thereof.

Different types of said compound can be employed in the electrolyte and at the anode or cathode, e.g. glycylglycine in the electrolyte and a peptide on the anode.

The electrolyte may have a pH from 10 to 14 i.e. is a basic solution. Particularly preferred solutions are formed of sodium or potassium hydroxide. However, a salt solution can also be used for example NaCl(aq).

Preferably, the pH of the electrolyte at the anode is substantially the same as the pH of the electrolyte at the cathode. This may for example be achieved by having a single compartment for the electrolyte.

The method can take place from room temperature up to about 80° C. and preferably from 15 to 60° C.

In a preferred embodiment, the electrolyte is a solution of glycine, glycylglycine (referred to hereafter as ‘gly-gly’), alanine, serine, or any combination thereof. The concentration of amino acid or peptide may be from 0.1 M to 0.5 M.

The current may be a constant current density from 5 to 20 mA/cm².

In accordance with a second aspect of the invention there is provided a method of carrying out electrolysis including the step of passing an electric current through an electrolyte in a cell as defined above. The method may be used to produce hydrogen by carrying out electrolysis on an aqueous solution.

A number of preferred embodiments of the invention will now be described, with reference to and as illustrated in the accompanying drawings, in which:

FIG. 1 is a graph showing the potential difference against time for the electrolysis of alkaline solution (1 M NaOH) with carbon anode and nickel plate cathode at 10 mA/cm² in presence and absence of gly-gly;

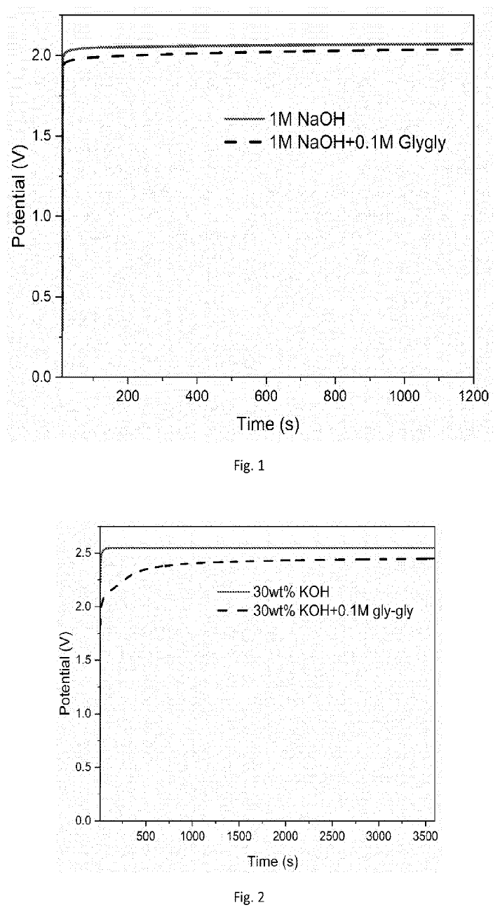

FIG. 2 is a graph for the electrolysis of alkaline solution (30% KOH) with carbon anode and nickel plate cathode at 10 mA/cm² in presence and absence of gly-gly;

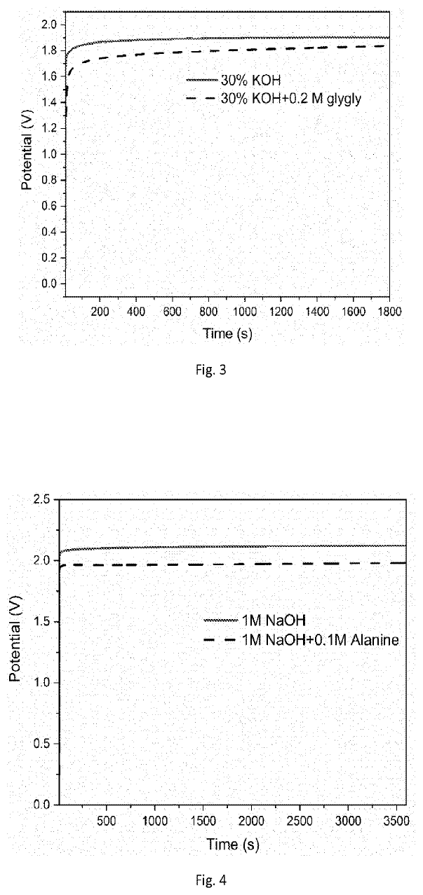

FIG. 3 is a graph for the electrolysis of alkaline solution (30% KOH) with carbon anode and nickel foam cathode at 10 mA/cm² in presence and absence of gly-gly;

FIG. 4 is a graph for the electrolysis of alkaline solution (1 M NaOH) with carbon anode and nickel plate cathode at 10 mA/cm² in presence and absence of alanine;

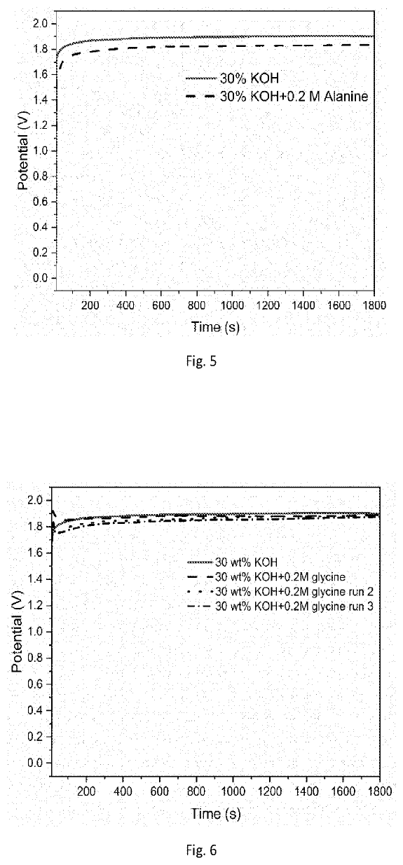

FIG. 5 is a graph for the electrolysis of alkaline solution (30% KOH) with carbon anode and nickel foam cathode at 10 mA/cm² in presence and absence of alanine;

FIG. 6 is a graph for the electrolysis of alkaline solution (30 wt % KOH) with carbon anode and nickel foam cathode at 10 mA/cm² in presence and absence of glycine at 50° C.;

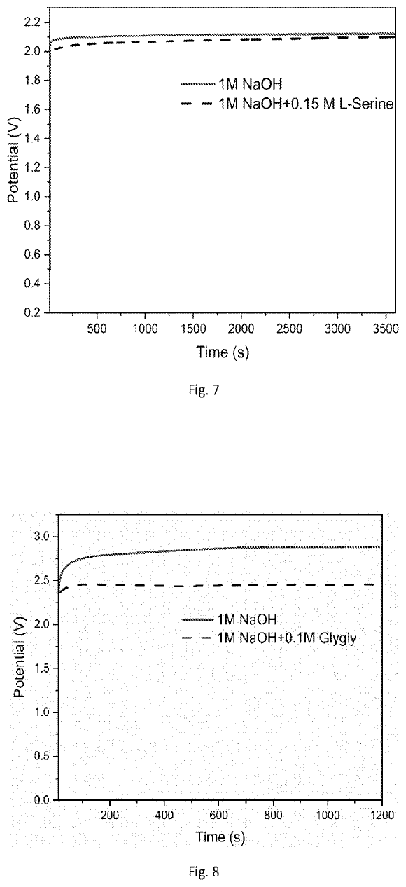

FIG. 7 is a graph for the electrolysis of alkaline solution (1 M NaOH) with carbon anode and nickel plate cathode at 10 mA/cm² in presence and absence of serine;

FIG. 8 is a graph for the electrolysis of alkaline solution (1 M NaOH) with carbon anode and copper plate cathode at 10 mA/cm² in presence and absence of gly-gly;

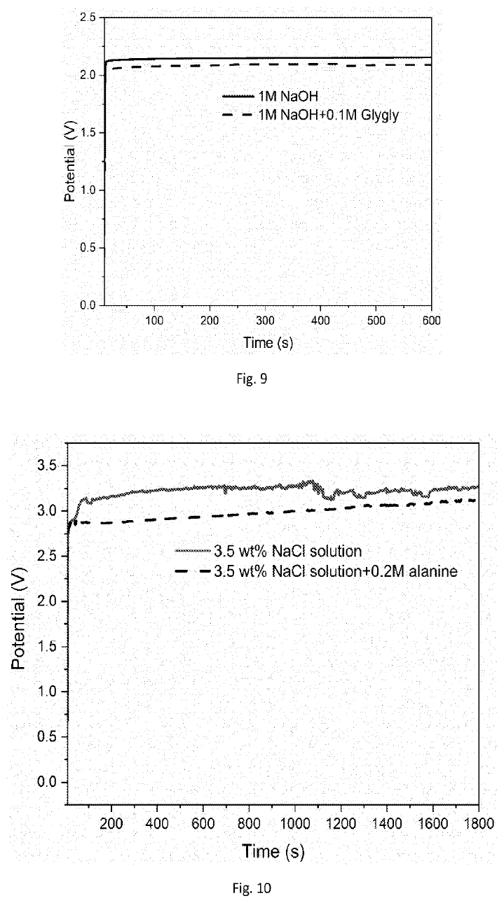

FIG. 9 is a graph for the electrolysis of alkaline solution (1 M NaOH) with carbon anode and stainless-steel plate cathode at 10 mA/cm² in presence and absence of gly-gly;

FIG. 10 is a graph for the electrolysis of 3.5 wt % NaCl solution with carbon anode and nickel foam cathode at 20 mA/cm² in presence and absence of 0.2 M alanine;

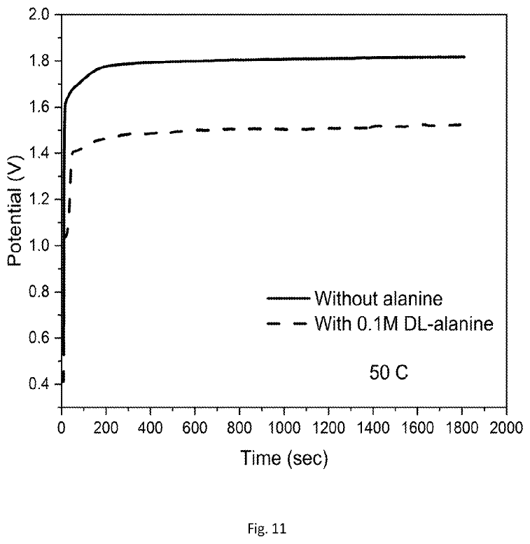

FIG. 11 is a graph for the electrolysis of alkaline solution (30 wt % KOH) with nickel oxide anode and nickel foam cathode at 15 mA/cm² in the presence and absence of DL-alanine at 50° C.;

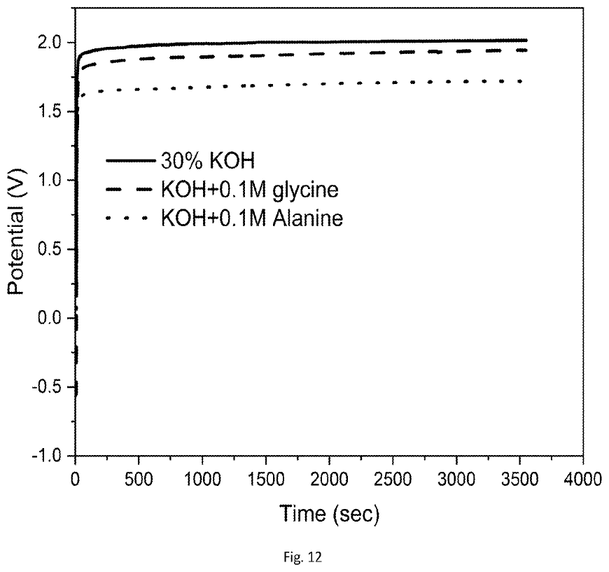

FIG. 12 is a graph for the electrolysis of alkaline solution (30 wt % KOH) with manganese oxide anode and nickel foam cathode at 15 mA/cm² in presence and absence of glycine or alanine at room temperature;

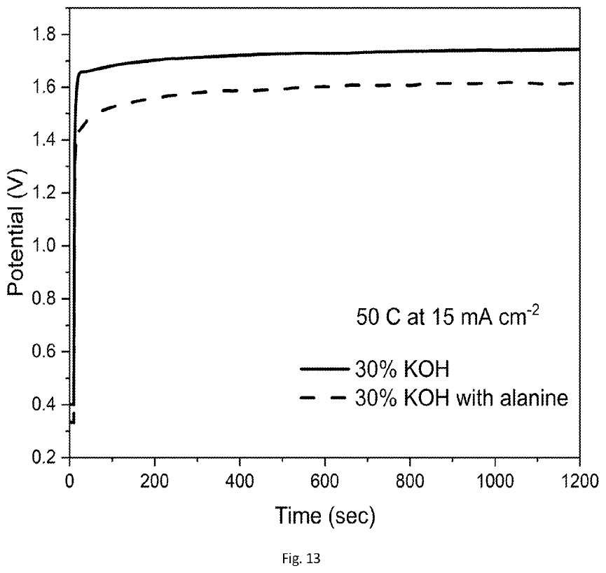

FIG. 13 is a graph for the electrolysis of alkaline solution (30 wt % KOH) with cobalt doped manganese oxide anode and nickel foam cathode at 15 mA/cm² in presence of alanine at 50° C.;

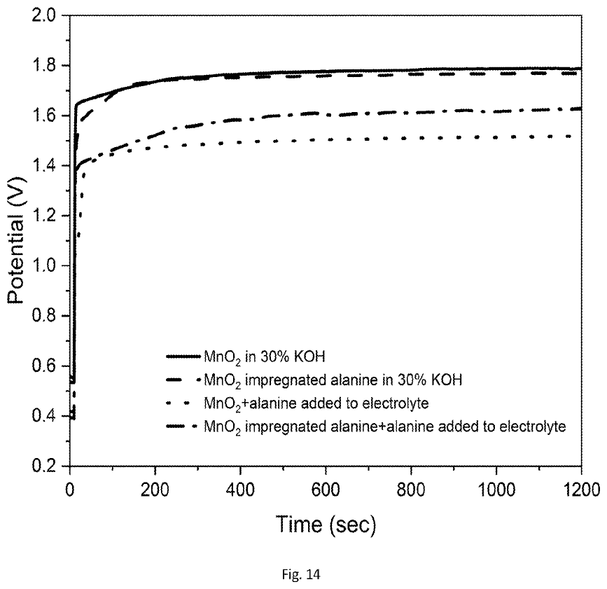

FIG. 14 is a graph for the electrolysis of alkaline solution (30 wt % KOH) with and without alanine using manganese oxide anode with and without impregnation of alanine and nickel foam cathode at 15 mA/cm² at 50° C.;

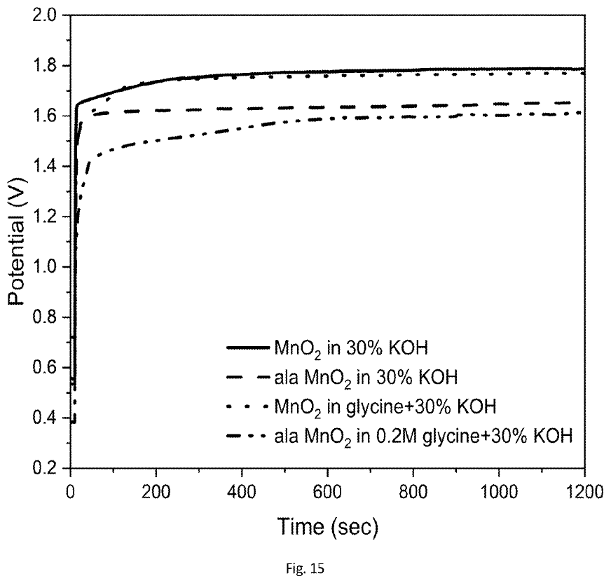

FIG. 15: is a graph for the electrolysis of alkaline solution (30 wt % KOH) with and without glycine using manganese oxide anode with and without impregnation of alanine and nickel foam cathode at 15 mA/cm² at 50° C.; and

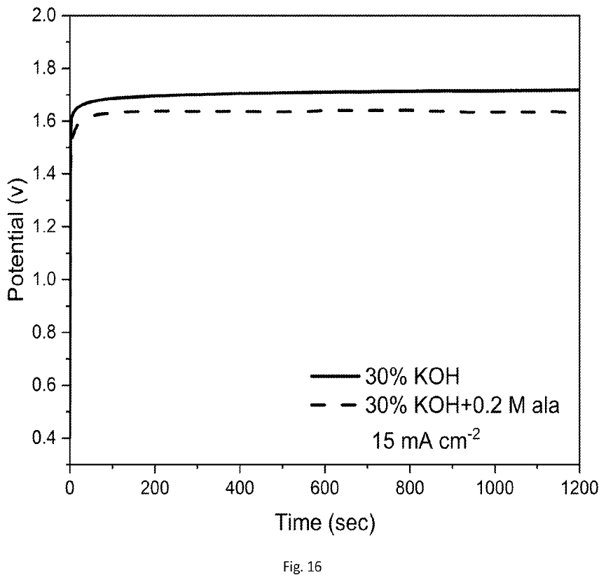

FIG. 16: is a graph for the electrolysis of alkaline solution (30 wt % KOH) with iron oxide anode and nickel foam cathode at 15 mA/cm² in presence and absence of alanine at 35° C.

### EXPERIMENTAL

The electrochemical cell consists of cathode, anode and electrolyte. The electrolytes are 1 M NaOH or 30% KOH with and without the addition of amino acids (gly-gly/alanine/serine). The anode is graphite and the cathode is either nickel plate/nickel foam/copper plate/stainless steel.

A constant current (10 mA/cm⁻²) is passed through the electrodes to split the electrolyte and generate hydrogen at the cathode and oxygen at the anode. The aim is to reduce the overpotential of hydrogen production. Thermodynamically, water splitting potential is 1.23 V and by electrode and electrolyte modifications, the overpotential can be reduced. Until now most research considers the modifications of electrodes, and little has been done on modifying the electrolyte.

The current results show that addition of amino acids to KOH/NaOH electrolyte at different concentrations and different temperatures reduce the overpotential for hydrogen production. Below are the results which summarise the effect of addition of amino acids on the overpotential of the hydrogen production.

### Results

In FIG. 1 with 1 M NaOH and using carbon anode and nickel plate as cathode, a constant current density of 10 mA/cm² was applied. The black line shows that to keep the current density constant (i.e. constant hydrogen production at the cathode), a potential of about 2 V is required. However, on addition of 0.1 M glygly amino acid, a reduction of potential by 0.1 V is observed. It clearly means that the power requirement for the hydrogen production is going to be less when amino acid is added.

On changing the electrolyte to 30% KOH (industrial standard) and at room temperature, we can see similar phenomena. FIG. 2 compares the potential obtained on passing 10 mA/cm⁻² current density. A potential of 2.5 V is needed to produce hydrogen with 30% KOH whereas on addition of 0.1 M glygly, a decrease of potential to 2.3 V is observed.

The influence of temperature on the hydrogen production was also tested. FIG. 3 shows the hydrogen production at 50° C. with a nickel foam cathode. As the production of hydrogen increased, formation of foam was observed in nickel plate and to avoid any diffusion factors, nickel foam (industrial standard) was used as the cathode. It is evident from FIG. 3 that on passing a current density of 10 mA/cm² (projected area of the Ni foam), without the amino acid, a potential of 1.8 V is required whereas on addition of glygly, a decrease in potential by 100 mV is observed. This clearly means that the power requirement to produce same amount of hydrogen would be lower on addition of amino acid.

Besides glygly, other amino acids were also tried. Experiments with alanine added to both 1 M NaOH and 30% KOH (50° C.) showed reduction in the overpotential by about 100 mV for 1 hour and 30 minutes of the process, respectively (FIGS. 4 and 5). Again, as same amount of charge density is passed for hydrogen production, the lower overpotential means that the power requirement for hydrogen production is lower on addition of alanine.

Addition of 0.2 M glycine in the electrolyte was also performed. FIG. 6 shows the influence of glycine of hydrogen production. It is observed that on addition of glycine, the overpotential reduction is not much. However, on running the experiment for 30 minutes followed by 10 minutes rest and running again in the same electrolyte for 30 minutes, the overpotential decreases (blue line). On running for the 3^{rd} time, the overpotential decreases further (green line). The experiment suggests that in situ electrode modification is occurring during the electrolysis process which leads to consequent decrease in overpotential on running the experiments.

FIG. 7 shows the hydrogen production on addition of serine in 1 M NaOH at room temperature. It is evident that after 1 hour of the electrolysis, the overpotential in the electrolyte containing serine is lower compared to without the amino acid. This means that the power requirement is lowered for hydrogen production on addition of serine. However, with 30% KOH and at 50° C., it was observed that serine decomposes and forms ammonia (therefore the results have not been included).

Electrolysis was also performed by changing the cathode from nickel to copper and stainless steel. FIGS. 8 and 9 show the influence of gly-gly on hydrogen production. It is evident from the figures that even with a change in cathode the overpotential for hydrogen production is lower on addition of amino acids.

Electrolysis was also performed by changing the electrolyte from hydroxides to 3.5 wt % sodium chloride using nickel foam cathode and carbon anode. FIG. 10 compares the influence of addition of alanine on hydrogen production in the chloride electrolyte. It is evident from FIG. 10 that on addition of alanine, a decrease in the overpotential for hydrogen production occurs from which it can be concluded that amino acids affect the electrochemical process even when there is a change in pH.

Electrolysis was also performed by changing the anode from carbon to nickel oxide. Nickel oxide was produced simply by heating a nickel foam in air at 200° C. for 24 hours. FIG. 11 shows the influence of alanine on hydrogen production. It is evident from the figure that compared to carbon anodes, the potential is reduced considerably for hydrogen production. The addition of amino acids decreases the hydrogen potential production significantly.

Electrolysis was also performed by changing the anode to manganese oxide. Manganese oxide was produced by electrochemical deposition onto a nickel foam from Manganese acetate/manganese sulphate electrolyte by passing a constant current for 10 minutes. FIG. 12 shows the influence of alanine and glycine on hydrogen production. It is evident from the figures that the addition of amino acids decreases the hydrogen potential production significantly.

Electrolysis was also performed by changing the anode to cobalt doped manganese oxide. Cobalt doped manganese oxide was produced by electrochemical deposition onto a nickel foam from manganese acetate and cobalt acetate electrolyte by passing a constant current for 10 minutes. FIG. 13 shows the influence of alanine and glycine on hydrogen production at 50° C. It is evident from the figure that the addition of amino acids decreases the hydrogen potential production significantly.

Electrolysis was also performed by using manganese oxide and manganese oxide impregnated with amino acid. Manganese oxide was produced by electrochemical deposition onto a nickel foam from manganese acetate/manganese acetate with alanine electrolyte by passing a constant current for 10 minutes A slight decrease in hydrogen potential was observed. On addition of amino acid to the electrolyte, a significant drop in hydrogen potential is observed which is lower than just having amino acid in the electrolyte which means that a synergetic effect is taking place on having amino acid in the electrode and electrolyte. FIG. 14 shows the influence of alanine addition in the electrode and electrolyte on hydrogen production at 50° C. It is evident from the figure that the addition of amino acids to the electrode and electrolyte decreases the hydrogen potential production significantly.

Electrolysis was also performed by using manganese oxide and manganese oxide impregnated with amino acid. Manganese oxide was produced by electrochemical deposition onto a nickel foam from manganese acetate/manganese acetate with alanine electrolyte by passing a constant current for 10 minutes A slight decrease in hydrogen potential was observed. On addition of a different amino acid (glycine) to the electrolyte, a significant drop in hydrogen potential is observed which is lower than just having glycine in the electrolyte which means that a synergetic effect is taking place on having amino acid in the electrode and electrolyte. FIG. 15 shows the influence of alanine addition in the electrode and electrolyte on hydrogen production at 50° C. It is evident from the figure that the addition of amino acids to the electrode and electrolyte decreases the hydrogen potential production significantly.

Electrolysis was also performed by changing the anode to iron oxide. Iron oxide was produced by electrochemical deposition onto a nickel foam from iron chloride electrolyte by passing a constant current for 10 minutes. FIG. 16 shows the influence of alanine and glycine on hydrogen production. It is evident from the figure that the addition of amino acids decreases the hydrogen potential production significantly

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 2118429.6 from which this application claims priority, and in the abstract accompanying this application are incorporated herein by reference.

1. An electrochemical cell including
an anode,
a cathode
and an electrolyte in contact with the anode and the cathode,
wherein the electrolyte and at least one of the anode or the cathode includes a compound which includes an amino group, wherein the concentration of said compound in the electrolyte is from 0.1 M to 0.5 M.

2. A cell as claimed in claim 1, wherein the anode is formed from carbon, a metal, or a combination of a metal and a metal oxide.

3. (canceled)

4. A cell as claimed in claim 2, wherein the anode is formed from a metal with a surface layer which includes a metal oxide.

5. A cell as claimed in claim 2, wherein the metal oxide is manganese oxide, cobalt-doped manganese oxide, nickel oxide or iron oxide.

6. A cell as claimed in claim 1, wherein said compound is an amino acid, a peptide, or any combination thereof.

7. A cell as claimed in claim 1, wherein the electrolyte has a pH from 10 to 14.

8. A cell as claimed in claim 1, wherein the anode includes said compound.

9. A cell as claimed in claim 1, wherein said compound is glycine, glycylglycine, alanine, serine, or any combination thereof.

10. (canceled)

11. A cell as claimed in claim 1, wherein the electrolyte includes KOH, NaOH or NaCl.

12. A cell as claimed in claim 1, wherein the electrolyte includes one of said compound and at least one of the anode or the cathode includes a different one of said compound.

13. A cell as claimed in claim 1, wherein the pH of the electrolyte at the anode is substantially the same as the pH of the electrolyte at the cathode.

14. A method of carrying out electrolysis including providing a cell which includes an anode, a cathode and an electrolyte in contact with the anode and the cathode, wherein the electrolyte and at least one of the anode or the cathode includes a compound which compound includes either an amino group, or a carboxyl group or both wherein the concentration of said compound in the electrolyte is from 0.1 M to 0.5 M, and passing an electric current through said electrolyte.

15. A method as claimed in claim 14 which is carried out at a temperature of 80° C. or less.

16. A method as claimed in claim 15 wherein the temperature is from 15 to 60° C.

17. A method of producing hydrogen, including carrying out electrolysis as claimed in claim 14 on an aqueous solution.

18. A method as claimed in claim 14, wherein the electrolyte has a pH from 10 to 14.

19. A method as claimed in claim 14, wherein said compound is glycine, glycylglycine, alanine, serine, or any combination thereof.

20. A method as claimed in claim 14, wherein the electrolyte includes KOH, NaOH or NaCl.

21. A method as claimed in claim 14, wherein the electrolyte includes one of said compound and at least one of the anode or the cathode includes a different one of said compound.

22. A method as claimed in claim 14, wherein the pH of the electrolyte at the anode is substantially the same as the pH of the electrolyte at the cathode.
